(19) United States
(12) Patent Application Publication
(10) Pub. No.: US 2020/0285586 A1
(43) Pub. Date: Sep. 10, 2020

(54) Method For Redirecting Unmapped Addresses of a Solid-State Drive

(71) Applicants: Goke Taiwan Research Laboratory Ltd., Taipei City (TW); Xinsheng Intellingent Technology Co., Ltd., JIANGSU (CN)

(72) Inventors: Po-Chien Chang, Taipei City (TW); Yung-Tzu Huang, Yilan City (TW)

(21) Appl. No.: 16/294,089

(22) Filed: Mar. 6, 2019

(51) Int. Cl. G06F 12/10

(52) U.S. Cl. CPC G06F 12/10; G06F 2212/7201

(57) ABSTRACT

A method is devised to redirect unmapped addresses of a solid-state drive. In the method, a NAND memory is provided with blocks each of which comprises pages. One block is selected from the blocks of the NAND memory. A number of the pages of the selected block are selected to be ‘0’-specific pages and programmed to be ‘0.’ Another number of the pages of the selected block are selected to be ‘1’-specific pages and programmed to be ‘1.’ The other pages of the selected are ordinary pages. Received from a host is a request for reading data from an address of the solid-state drive. It is determined whether the address is an unmapped address. A ‘0’ or ‘1’ is sent to the host (26) from a ‘1’- or ‘1’-specific page if the address is an unmapped address.

### BACKGROUND OF INVENTION

### 1. Field of Invention

The present invention relates to a solid-state drive and, more particularly, to a method for redirecting unmapped addresses of a solid-state drive.

### 2. Related Prior Art

When a host wants to read from an unmapped address of a solid-state drive (‘SSD’), the SSD has to provide a ‘0’ or ‘1’ to the host as required. To this end, the SSD programs a ‘0’-specific portion of a NAND memory to be ‘0’ and a ‘1’-specific portion of the NAND memory to be ‘1’. Every time the host wants to read from an unmapped address, a ‘0’ is provided to the host from the first portion of the SSD if so required or a ‘2’ is provided to the host from the second portion of the SSD if so required. This process is called ‘redirecting.’

Referring to FIG. 4, according to a conventional redirecting process, a first page of a block of the NAND memory is used as the ‘0’-specific portion, and a second page of this block is used as the ‘1’-specific portion. As requested by the host, the ‘0’-specific portion or ‘1’-specific portion of the NAND memory may be read many times, and this could entail ‘read disturb’, i.e., a NAND memory will be out of order if a page is read a certain number of times although the other portions of the NAND memory are barely used.

Referring to FIG. 5, according to another conventional redirecting process, a buffer of a random access memory (‘RAM’) of the SSD is used as the ‘0’-specific portion and another buffer of the RAM is used as the ‘1’-specific portion, thereby preventing the read disturb. However, there are problems with the use of the RAM for directing. Firstly, the cost of the SSD is increased for a RAM of a larger size must be used. Secondly, design of software for the SSD is difficult because the host might read from the RAM or the NAND memory.

The present invention is therefore intended to obviate or at least alleviate the problems encountered in prior art.

### SUMMARY OF INVENTION

It is the primary objective of the present invention to provide an effective and inexpensive method for redirecting unmapped addresses of a SSD.

To achieve the foregoing objectives, the method includes the step of providing a NAND memory with blocks each of which comprises pages. One block is selected from the blocks of the NAND memory. A number of the pages of the selected block are selected to be ‘0’-specific pages and programmed to be ‘0.’ Another number of the pages of the selected block are selected to be ‘1’-specific pages and programmed to be ‘1.’ The other pages of the selected are ordinary pages. Received from a host is a request for reading data from an address of the solid-state drive. It is determined whether the address is an unmapped address. A ‘0’ or ‘1’ is sent to the host (26) from a ‘0’- or ‘1’-specific page if the address is an unmapped address.

Other objectives, advantages and features of the present invention will be apparent from the following description referring to the attached drawings.

### BRIEF DESCRIPTION OF DRAWINGS

The present invention will be described via detailed illustration of the preferred embodiment versus the prior art referring to the drawings wherein:

FIG. 1 is a block diagram of a solid-state drive according to the preferred embodiment of the present invention;

FIG. 2 is a flow chart of a method for redirecting unmapped addresses of the solid-state drive shown in FIG. 1;

FIG. 3 is a block diagram of a host and the solid-state drive shown in FIG. 1;

FIG. 4 is a block diagram of a conventional solid-state drive; and

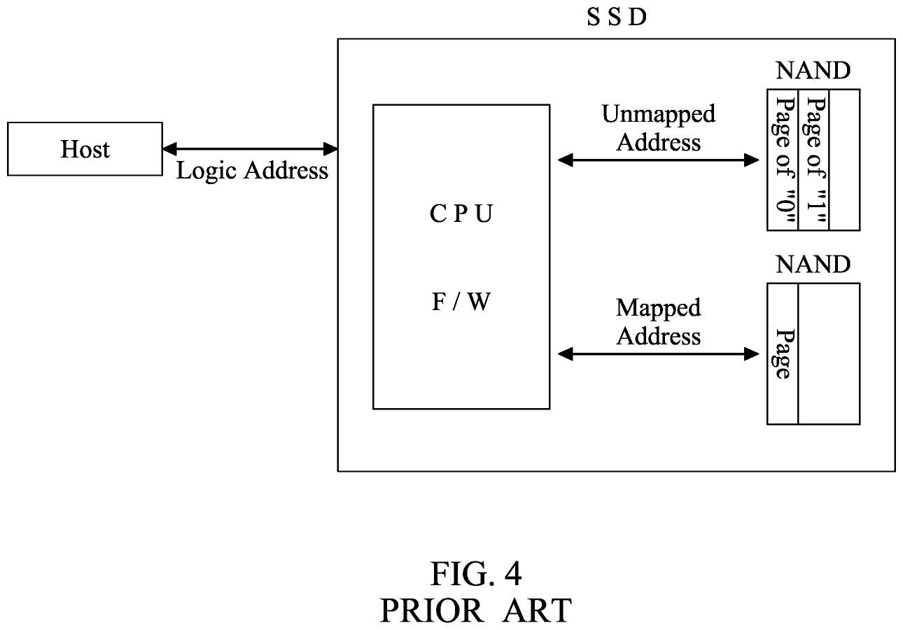

FIG. 5 is a flow chart of a method for redirecting unmapped addresses of the solid-state drive shown in FIG. 4.

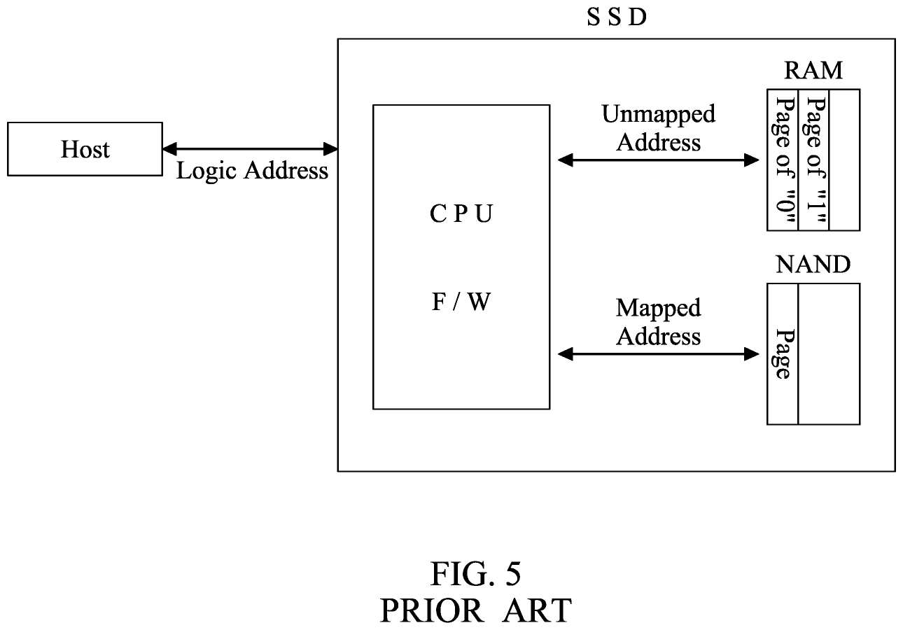

### DETAILED DESCRIPTION OF PREFERRED EMBODIMENT

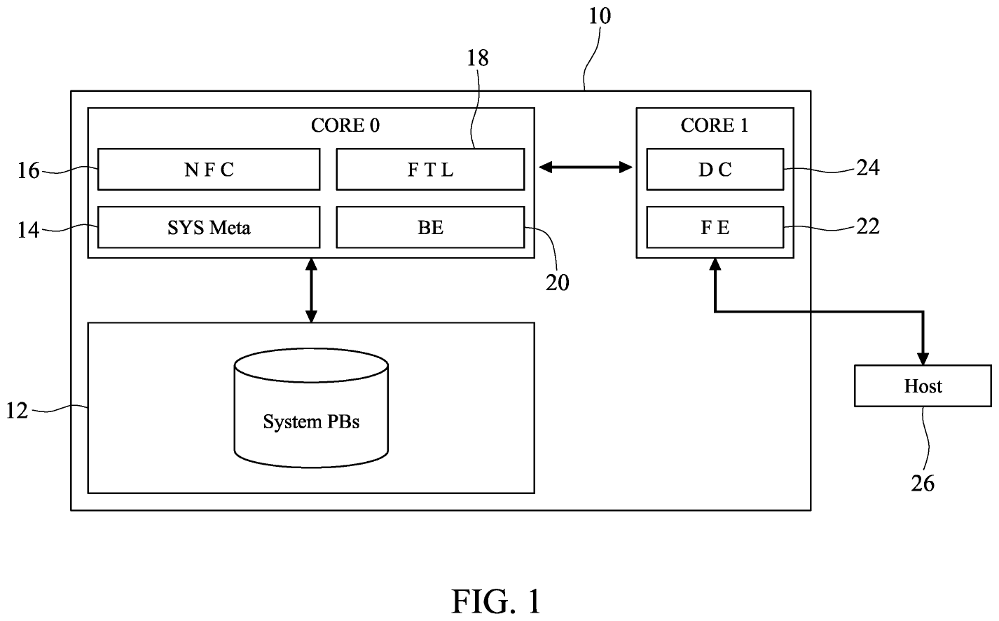

Referring to FIG. 1, a solid-state drive (‘SD’) 10 includes two central processor units (‘CPU’) and a NAND memory 12. One of the CPUs will be referred to as ‘Core 0’ while the other CPU will be referred to as ‘Core 1.’

Core 0 executes some software programs such as a system metadata (‘SysMeta’) 14, a NAND flash controller (‘NFC’) 16, a flash translation layer (‘FTL’) 18 and a back end (‘BE’) 20.

Core 1 runs some other software programs such as a front end (‘FE’) 22 and a data cache (‘DC’) 24.

The NAND memory 12 includes many blocks each of which includes many pages. Preferably, the blocks can be grouped into N groups each of which includes several blocks. However, in another embodiment, the blocks are not grouped.

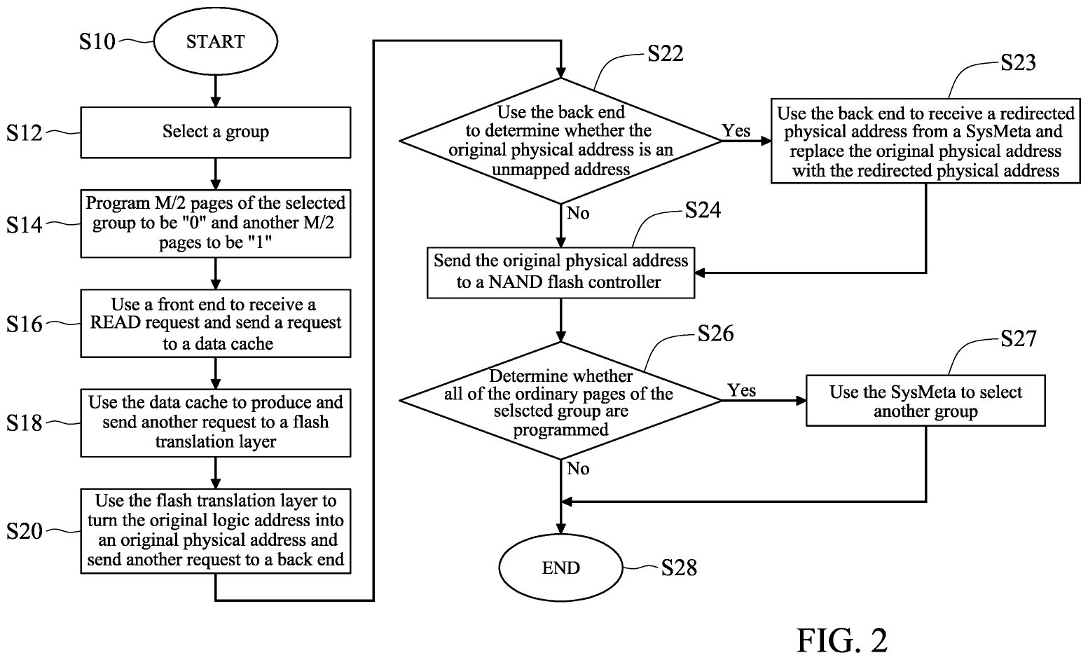

Referring to FIG. 2, there is a method for redirecting unmapped addresses of the SSD 10.

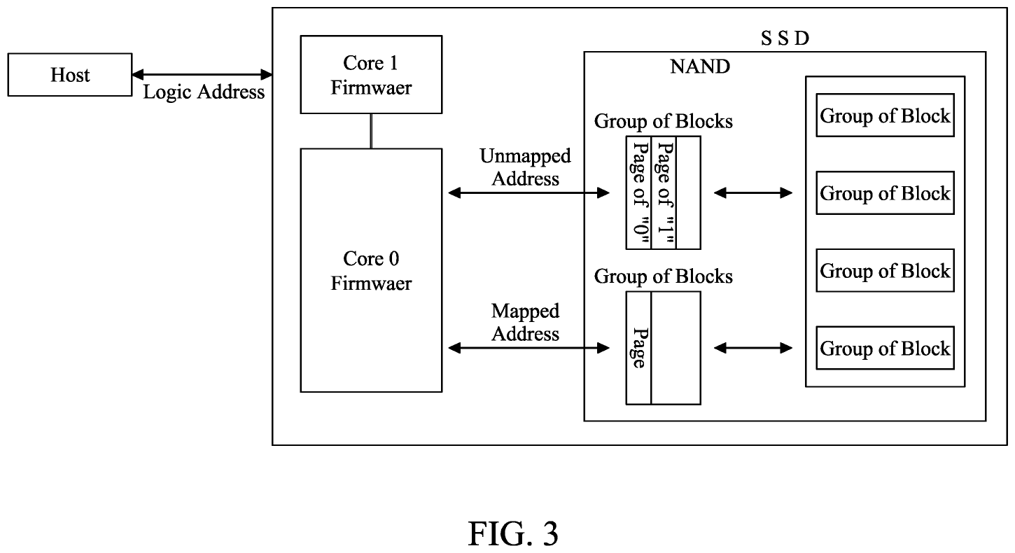

Referring to FIGS. 2 and 3, at S10, the process starts.

At S12, the SysMeta 14 is executed to select one group from the N groups.

At S14, the SysMeta 14 calls the NAND flash controller 16 to select M/2 pages from the pages of the selected group and program the M/2 pages to be ‘0’, and select and program another M/2 pages to be ‘1.’ For clarity of the description, the M pages will be called ‘specific pages’ while the other pages will be called ‘ordinary pages.’ The M/2 pages filled with ‘0’ are ‘0’-specific pages and the M/2 pages filled with ‘1’ are ‘1’-specific pages. When a group is selected, data are generally stored in the ordinary pages of the selected group.

At S16, the front end 22 receives a request for reading data (‘READ request’) from the host 26. The READ request includes a logic address (‘original logic address’). Hence, the front end 22 produces and sends a request to the data cache 24.

At S18, after receiving the request from the front end 22, the data cache 24 produces and sends another request to the flash translation layer 18.

At S20, after receiving the request from the data cache 24, the flash translation layer 18 turns the original logic address into an original physical address, and sends another request to the back end 20.

At S22, the back end 20 determines whether the original physical address is an unmapped address.

The process goes to S24 and the original physical address is sent to the NAND flash controller 16 if the original physical address is not an unmapped address.

The process goes to S23 before going to S24 if the original physical address is an unmapped address.

At S23, the back end 20 receives a redirected physical address from the SysMeta 14, and replaces the original physical address with the redirected physical address. Then, the back end 20 sends the redirected physical address to the NAND flash controller 16.

At S24, the NAND flash controller 16 sends ‘0’ or ‘1’ to the host 26 from the redirected physical address, or sends other data to the host 26 from the original physical address.

At S26, it is determined whether all of the ordinary pages of the selected group are programmed (or ‘written’). The process goes to S27 if all of the ordinary pages of the selected group are programmed. Otherwise, the process goes to S28.

At S27, the SysMeta 14 selects another group.

At S28, the process ends.

The invention exhibits several advantages over the prior art. Firstly, the life of the SSD 10 is relatively long. The possibility of read disturb is low for using M×N pages to store ‘0’ and ‘1.’ Secondly, the cost of the SSD 10 is relatively low. The SSD 10 does not have to include a large and hence expensive RAM for not using any capacity of a RAM to handle the unmapped addresses. Thirdly, design of the software programs for the SSD 10 relatively simple for only the NAND memory 12 provides data to the host 26.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A method for redirecting unmapped addresses of a solid-state drive, the method comprising the steps of:
providing a NAND memory (12) with blocks each of which comprises pages;
selecting one block from the blocks of the NAND memory;
selecting a number of the pages of the selected block to be ‘0’-specific pages and programming the ‘0’-specific pages to be ‘0’;
selecting another number of the pages of the selected block to be ‘1’-specific pages and programming the ‘1’-specific pages to be ‘1’;
using the other pages of the selected as ordinary pages;
receiving from a host (26) a request for reading data from an address of the solid-state drive (10);
determining whether the address is an unmapped address;
sending a ‘0’ or ‘1’ to the host (26) from a ‘0’- or ‘1’-specific page if the address is an unmapped address.

2. The method according to claim 1, further comprising the steps of:
determining whether all of the ordinary pages of the selected block are programmed;
continuing to use the selected block if all of the ordinary pages of the selected block are not programmed; and
selecting another block if all of the ordinary pages of the selected block are programmed.

3. A method for redirecting unmapped addresses of a solid-state drive comprising a NAND memory (12), a SysMeta (14), a NAND flash controller (16), a flash translation layer (18), a back end (20), a front end (22) and a data cache (24), wherein the NAND memory (12) comprising blocks each of which comprises pages, the method comprising the steps of:
(S12) executing the SysMeta (14) to select a block from the blocks;
(S14) using the SysMeta (14) to call the NAND flash controller (16) to select a number of the pages of the selected block to be ‘0’-specific pages and program the ‘0’-specific pages to be ‘0’, select another number of the pages of the selected block to be ‘1’-specific pages and program the ‘1’-specific pages to be ‘1’, and use the other pages of the selected as ordinary pages;
(S16) executing the front end (22) to receive from a host (26) a data-reading request that comprises an original logic address, and send a DC request to the data cache (24);
(S18) executing the data cache (24) to produce and send an FTL request to the flash translation layer (18);
(S20) executing the flash translation layer (18) to turn the original logic address into an original physical address and send a BE request to the back end (20);
(S22) executing the back end (20) to determine whether the original physical address is an unmapped address;
(S24) sending the original physical address to the NAND flash controller (16) if the original physical address is not an unmapped address;
(S23) executing the back end (20) to receive a redirected physical address from the SysMeta (14), replace the original physical address with the redirected physical address, and send the redirected physical address to the NAND flash controller (16) if the original physical address is an unmapped address;
(S24) using the NAND flash controller (16) to send a ‘0’ or ‘1’ to the host (26) from the redirected physical address or send other data to the host (26) from the original physical address.

4. The method according to claim 3, further comprising the steps of:
(S26) determining whether all of the ordinary pages of the selected block are programmed;
(S27) executing the SysMeta (14) to select another block if all of the ordinary pages of the selected block are programmed; and
(S28) stopping the process if otherwise.
